(19) United States
(12) Patent Application Publication
(10) Pub. No.: US 2025/0326045 A1
(43) Pub. Date: Oct. 23, 2025

(54) DEVICES, SYSTEMS, AND METHODS FOR WELDING

(71) Applicant: Sunstone Engineering LLC, Payson, UT (US)

(72) Inventor: Larin Amos Dodgen, Payson, UT (US)

(21) Appl. No.: 18/639,483

(22) Filed: Apr. 18, 2024

(51) Int. Cl. B23K 9/067

(52) U.S. Cl. CPC B23K 9/067

(57) ABSTRACT

A welding system may include a power source. A welding system may include a capacitor connected to the power source. The capacitor may be variably chargeable to a capacitor energy. A welding system may include an ignitor connected to the power source, the ignitor having an ignition current of between 0.5 A and 4 A. A welding system may include an electrode connected to the capacitor and the ignitor. A welding system may include an electrode retractor connected to the electrode to move the electrode between an extended position and a retracted position.

### BACKGROUND

Welding is a process by which two metallic objects may be joined. Many welding systems melt at least one of the metallic objects. Heat to melt the metallic objects may come from any source. For example, an arc welder may generate an electric arc between an electrode and the metallic object to melt one or more of the objects.

### BRIEF SUMMARY

In some aspects, the techniques described herein relate to a welding system. The welding system includes a power source. A capacitor is connected to the power source. The capacitor is variably chargeable to a capacitor energy. An ignitor is connected to the power source. The ignitor has an ignition current of between 0.5 A and 4 A. An electrode is connected to the capacitor and the ignitor. An electrode retractor is connected to the electrode to move the electrode between an extended position and a retracted position.

In some aspects, the techniques described herein relate to a method for welding. A weld controller charges a capacitor to a capacitor energy. After the capacitor is charged to the capacitor energy, and at a first time, the weld controller provides an ignition current from an ignitor to an electrode. At the first time and while applying the ignition current to the electrode, the weld controller starts a retraction of the electrode from an extended position to a retracted position. At a second time a discharge delay after the first time, the weld controller triggers a discharge of the capacitor.

In some aspects, the techniques described herein relate to a method for welding. A weld controller receives an energy input for a welding energy. Based on the energy input, the weld controller charges a capacitor to a capacitor energy. When the capacitor is charged to the capacitor energy, the weld controller applies an ignition current to an electrode. While applying the ignition current to the electrode, the weld controller retracts the electrode from a welding surface. After a discharge delay after retracting the electrode from the welding surface, the weld controller discharges the capacitor through the electrode, the discharge delay based on the welding energy.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is a representation of a welding system, according to at least one embodiment of the present disclosure.

FIG. 2 is a schematic representation of a welding system, according to at least one embodiment of the present disclosure.

FIG. 3 is a relationship plot of a relationship between welding energy ignition current illustrated tip offset, according to at least one embodiment of the present disclosure.

FIG. 4-1 through FIG. 4-4 illustrate a schematic representation of a welding sequence 452 at different times, according to at least one embodiment of the present disclosure.

FIG. 5 is a representation of a welding sequence illustrating capacitor charge, ignition current, and tip offset, according to at least one embodiment of the present disclosure.

FIG. 6 is a representation of a welding system, according to at least one embodiment of the present disclosure.

FIG. 7 is a flowchart of a method for welding, according to at least one embodiment of the present disclosure.

FIG. 8 is a flowchart of a method for welding, according to at least one embodiment of the present disclosure.

FIG. 9 is a representation of a computing system, according to at least one embodiment of the present disclosure.

### DETAILED DESCRIPTION

This disclosure generally relates to devices, systems, and methods for welding. An arc welding system utilizes an electrical current to melt and join two materials. During a weld, an electrode is placed at a weld location proximate a weld surface. The arc welding system may include capacitor discharge welding, in which a capacitor is charged and discharged through the electrode to perform the weld. Conventionally, for low-energy welds (e.g., welds having a weld energy of less than 5 J), the capacitor may be discharged to an unpowered electrode. This may generate impurities at the weld site and/or the electrode, resulting in increased electrode when the electrode is cleaned. In some embodiments, capacitor discharge to an uncharged electrode may cause the electrode to be welded to the weld surface, resulting in damage to the electrode tip and/or the weld surface.

In accordance with at least one embodiment of the present disclosure, an ignitor may apply an ignition current to the electrode prior to discharging the capacitor. The ignition current may start the formation of an electrical arc between the electrode and the welding surface. While applying the ignition current, a welding controller may retract the electrode from the welding surface. After a discharge delay, and while the electrode is retracted from the welding surface, the welding controller may cause the capacitor to discharge in a discharge circuit including the electrode. Discharging the capacitor may intensify the electrical arc between the electrode and the welding surface, which may heat the welding surface to above a melting temperature of the material to be welded. The capacitor may finish discharging, and the electrode may be returned to its original position. In this manner, and in accordance with at least one embodiment of the present disclosure, the welding device may result in increased weld quality and/or reduced wear on the electrode.

In some embodiments, the discharge delay may be associated with an electrode tip distance between the welding surface and the electrode tip. For example, the discharge delay may begin when the ignition current is applied to the electrode. At this same time, the electrode may begin retracting. The rate of retraction of the electrode may be based on the retraction mechanism, and the tip distance may be determined based on the rate of retraction and the discharge delay.

In accordance with at least one embodiment of the present disclosure, the discharge delay and/or the tip distance may be based, at least partially, on the welding energy. In some embodiments, the discharge delay and/or the tip distance may be positively related to the welding energy. For example, a larger discharge delay and/or tip distance may be based on a larger welding energy. In some examples, a smaller discharge delay and/or tip distance may be based on a smaller welding energy. As discussed in further detail herein, as the welding energy increases, the intensity of the resulting arc increases. Basing the discharge delay and/or the tip distance on the welding energy may improve weld quality and/or reduce damage and wear and tear to the electrode tip.

As illustrated by the foregoing discussion, the present disclosure utilizes a variety of terms to describe features and advantages of the welding and low-current ignition systems. Additional detail is now provided regarding the meaning of such terms. For example, as used herein, the term “welding energy” refers to the energy of a weld during the welding process. The welding energy may be the amount of energy for a single weld. For example, one or more welding devices of the present disclosure may be capacitive discharge welders that discharge the energy stored in a capacitor to form the weld. In some embodiments, the welding energy may refer to the energy stored in the capacitor when the capacitor is discharged to form the weld. In some embodiments, the welding energy is the energy applied to the welding surface. In some embodiments, the welding energy may refer to the heat generated at the welding surface by the electric arc between the electrode tip and the welding surface. The welding energy may be different than the capacitor energy to account for losses in the welding system between the capacitor and one or more of the weld discharge circuit, the electrode, and the welding surface. In some embodiments, a plurality of resistor banks in series with a power supply may be used to store energy.

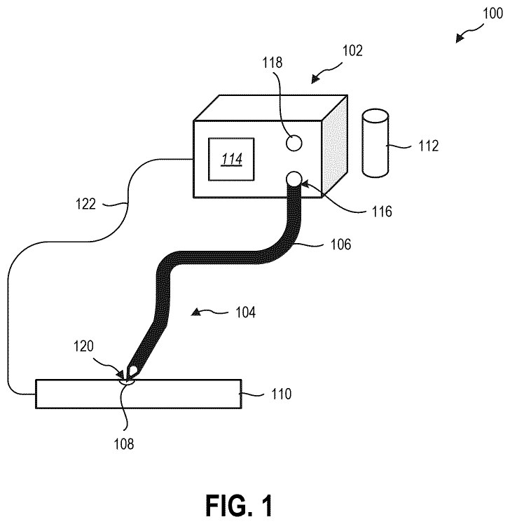

FIG. 1 is a representation of a welding system 100, according to at least one embodiment of the present disclosure. The welding system 100 includes a welding device 102. The welding device 102 may include a welding stylus 104 connected to the welding device 102 through a cable 106. The welding device 102 may provide electrical power to the welding stylus 104 to generate a weld 108 at a weld surface 110.

To generate the weld 108 at the weld surface 110, the welding device 102 may apply an electrical current to the welding stylus 104 through the cable 106. The welding device 102 may be any type of welding device. For example, in accordance with one or more embodiments, the welding device 102 may include any electric arc welder, such as a gas metal arc welding (GMAW) welder, metal inert gas (MIG), a tungsten inert-gas (TIG) welder, a pulse arc welder, any other electric arc welder, and combinations thereof. Embodiments of the present disclosure may be discussed with respect to a MIG or a TIG welder, but it should be understood that the techniques of the present disclosure may be applied to any compatible welding system.

While preparing the weld, the welding device 102 may provide a supply of an inert gas from a gas supply 112, through the cable 106 and to the weld site at the weld surface 110 through the welding stylus 104. The inert gas from the gas supply 112 may include ay type of inert gas including one or more noble gasses. In some embodiments, the gas supply 112 may include Argon (Ar), although any other inert gas may be used.

As discussed herein, the cable 106 may include both the electrical connection to the welding stylus 104 and the gas connection to the welding stylus 104. For example, the cable 106 may include an electrical wire or connection between the welding device 102 and the welding stylus 104, and, in the same cable 106, a gas tube in fluid communication (including one or more valves, pressure regulators, and/or flow directors) between the gas supply 112 and the welding stylus 104.

The welding device 102 may further include a user interface 114, a stylus connection 116, and a manual input 118. The user interface 114 may include a display that provides the user welding information, including instructions, charge status, number of welds, selected welding energy, support information, any other user information, and so forth. In some embodiments, the user interface 114 is interactive. For example, the user may provide input to the display to adjust one or more settings of the welding device 102. The user may interact with the user interface 114 in any manner, such as through an input device such as a mouse and/or through a touch-screen display. The cable 106 may be connected to the welding device 102 at the stylus connection 116.

In accordance with at least one embodiment of the present disclosure, the welding device 102 may have a variable welding energy. The welding energy may be representative of the total amount of energy applied to the weld surface 110 When performing different welds 108, a user may desire to use a variable amount of welding energy. The user may desire to use different amounts of welding energy for any reason and/or based on any welding factor. Some specific, non-limiting examples of reasons to use different amounts of welding energy may include different materials of the weld surface 110, different dimensions (e.g., thickness, length, width) of the weld surface 110, a desired weld size, a desired weld pattern, a desired weld type, joining two materials, closing a gap in a material, user preference, any other welding factor, and combinations thereof.

The user may select the variable welding energy in any manner. For example, the user may provide an input in the user interface 114 to adjust the variable welding energy. In some examples, the user may provide an input at the manual input 118. The manual input 118 may include a manual input having settings for the available welding energies for the welding device 102. While the manual input 118 is illustrated as a radial dial, it should be understood that the manual input 118 may include any type of manual input, including buttons for each weld energy, buttons to increase or decrease the weld energy, sliders, switches, any other manual input, and combinations thereof.

In accordance with at least one embodiment of the present disclosure, the welding device 102 may be a micro-welding device. A micro-welding device may generate relatively small welds, or welds having a small weld size. The weld size may be the largest dimension of the weld (e.g., width/diameter, height above welding surface, penetration into the welding material). Micro-welding is performed on small, thin, and/or delicate materials to maintain the integrity and/or visual aesthetics of the weld and the target material. In some embodiments, the weld size may be in a range having an upper value, a lower value, or upper and lower values including any of 0.1 mm, 0.2 mm, 0.3 mm, 0.4 mm, 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.75 mm, 2.0 mm, 2.5 mm, 3.0 mm, 3.5 mm, or any value therebetween. For example, the weld size may be greater than 0.1 mm. In another example, the weld size may be less than 3.5 mm. In yet other examples, the weld size may be any value in a range between 0.1 mm and 3.5 mm. In some embodiments, it may be critical that the weld size is between 0.2 mm and 0.5 mm to maintain integrity and/or visual aesthetics of the welding surface.

The weld size may be influenced by multiple factors, including, but not limited to, the material type, the material thickness, and the welding energy. For example, a larger welding energy may result in a larger weld, and a smaller welding energy may result in a smaller weld. As discussed herein the user may desire to adjust the welding energy based on his or circumstances, materials, and preferences. In some embodiments, the welding energy may be in a range having an upper value, a lower value, or upper and lower values including any of 0.1 J, 0.5 J, 1.0 J, 1.5 J, 2.0 J, 2.5 J, 3 J, 3.5 J, 4.0 J, 4.5 J, 5.0 J, 6 J, 7 J, 8 J, 9 J, 10 J, 11 J, 12 J, 13 J, 14 J, 15 J, 16 J, 17 J, 18 J, 19 J, 20 J, 25 J, 30 J, 45 J, 60 J, 90 J, 120 J, 150 J, 200 J, 250 J, or any value therebetween. For example, the welding energy may be greater than 0.1 J. In another example, the welding energy may be less than 250 J. In yet other examples, the welding energy may be any value in a range between 0.1 J and 250 J.

The welding stylus 104 may include an electrode 120. The electrode 120 may be located at a tip of the welding stylus 104. The current to generate the weld may pass from the electrode 120 to the weld surface 110 to form the weld 108. In accordance with at least one embodiment of the present disclosure, the electrode 120 may be non-consumable. For example, the material from the electrode 120 may not be melted, ablated, evaporated, sublimated, or otherwise removed for the purposes of generating the weld 108. The electrode 120 may be formed of any material, such as tungsten.

To form the weld 108, the user may place the welding stylus 104 proximate to the weld area on the weld surface 110. The weld area may be the desired location of the weld. For example, the weld area may be a location for two materials to be joined. In some examples, the weld area may be a gap in material or between two materials that is to be filled or closed by the weld. In some examples, the weld area may be a on top of a sheet to be connected to an underlying material.

When the user desires to form the weld, the user may provide, to the welding device 102, an input indicating the intent to form a weld and the desired welding energy, such as by providing an input on the welding device 102. The welding device 102 may begin charging the capacitor to the desired welding energy. When the capacitor is charged, the welding device 102 may receive a trigger to initiate the weld. The trigger may be any type of trigger. For example, the trigger may include a user input, such as a foot trigger (e.g., a button or other input actuatable by a user's foot) or a hand trigger (e.g., a button or other input actuatable by a user's hand). In some examples, the trigger may include a sensor that detects when the electrode 120 is in contact with the weld surface 110, such as when a ground cable 122 is in contact with the weld surface 110.

When the welding device 102 detect the trigger, the welding device 102 may apply an ignition current to the electrode 120. Further, when the welding device 102 detects the trigger, the welding device 102 may begin retraction of the electrode 120 into the welding stylus 104. When the welding device 102 detects the trigger, the welding device 102 may initiate a discharge delay prior to discharging the capacitor. The discharge delay may be a delay between receiving the trigger and beginning discharge of the capacitor.

During the discharge delay, the electrode 120 may at least partially retract into the welding stylus 104. The ignition current may begin an electrical connection between the electrode 120 and the weld surface 110. After the discharge delay ends, the capacitor may begin discharging. The discharge from the capacitor may pass through the electrode 120 to the weld surface 110. The discharge of the capacitor may result in an electric arc between the electrode 120 and the weld surface 110. The discharged energy into the weld surface 110 may heat the weld surface 110. In some embodiments, the discharged energy into the weld surface 110 may heat the weld surface 110 above the melting temperature of the material composing the weld surface 110, thereby forming the weld 108. Discharging the capacitor after the discharge delay may result in increased weld 108 quality, increased reliability in forming the weld 108, decreased wear and tear on the electrode 120, and combinations thereof.

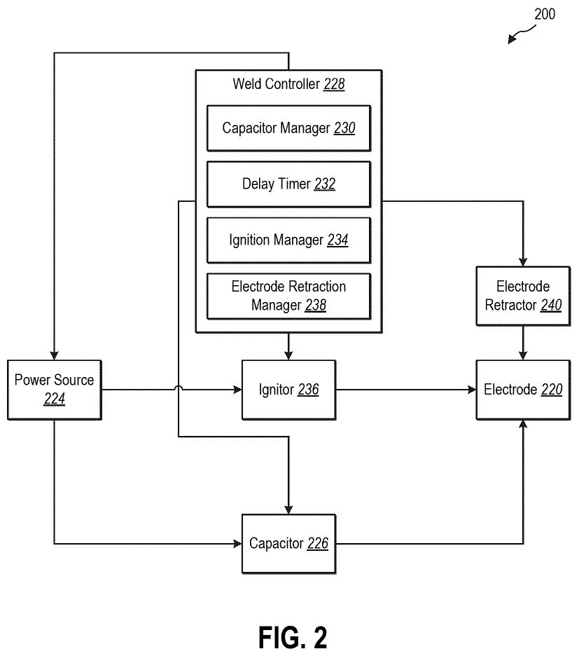

FIG. 2 is a schematic representation of a welding system 200, according to at least one embodiment of the present disclosure. The welding system 200 may include a power source 224. The power source 224 may be any type of power source. For example, the power source 224 may be connected to grid power. In some examples, the power source 224 may include a battery power. In some examples the power source 224 may include any other type of power source. In some embodiments, the power source 224 may have a power voltage. The power voltage of the power source 224 may include any input voltage, such as 20 V, 30 V, 40 V, 50 V, 60 V, 70V, 80 V, 90 V, 100 V, 110 V, 120 V, or any value therebetween. In some embodiments, an input voltage of 50 V may efficiently and quickly power the welding system 200.

The power source 224 may be connected to and charge a capacitor 226. In some embodiments, the power source 224 may charge the capacitor 226 to a variable energy storage. A user may provide an input of a welding energy to the welding system 200 through an input device. The power source 224 may charge the capacitor 226 based on the welding energy. For example, the power source 224 may charge the capacitor 226 to a capacitor charge based on the input or selected welding energy. In this manner, the capacitor 226 may be chargeable to a variable capacitor energy.

The welding system 200 may include a weld controller 228. The weld controller 228 may control operation of the welding system 200. When the welding system 200 receives the input to initiate a weld, a capacitor manager 230 may cause the power source 224 to charge the capacitor 226 to the selected input. For example, the power source 224 may apply a voltage differential to the capacitor 226 to build up a capacitor charge until the capacitor energy associated with the welding energy is stored in the capacitor 226. The power source 224 and the weld controller 228 may monitor the charge on the capacitor 226 until the capacitor has stored the capacitor energy associated with the welding energy. When the capacitor 226 has stored the capacitor energy, the weld controller 228 may cause the power source 224 to maintain the charge on the capacitor 226 until the capacitor 226 is discharged.

When the capacitor 226 is charged, the weld controller 228 may initiate the weld. In some embodiments, the weld controller 228 may initiate the weld as soon as the capacitor 226 is charged. In some embodiments, the weld controller 228 may initiate the weld after the capacitor 226 is charged and after receiving or detecting a trigger. The trigger may be any type of trigger. For example, the trigger may include a user input at an input device. For example, the user may press a foot trigger with his or her foot. In some examples, the user may press a button on the welding housing and/or the stylus to trigger the weld. In some examples, the trigger may include a sensed condition of the welding system. For example, the trigger may include a sensed condition of the stylus, the electrode 220, any other sensed condition, and combinations thereof. The sensed condition of the electrode 220 may include closing a circuit with a ground lead connected to the welding surface. For example, the welding system 200 may include a ground lead to close the welding circuit. The power source 224 may provide a sensing current through the electrode 220 to detect when the electrode 220 is in contact with the welding surface. Detecting that the electrode 220 is in contact with the welding surface may be the trigger to initiate the weld.

When the weld controller 228 receives the trigger to initiate the weld, a delay timer 232 may start a discharge delay. The discharge delay may be a delay between receiving the trigger to initiate the weld and discharging the capacitor. For example, when the weld controller 228 receives the trigger, the delay timer 232 may begin the discharge delay. After the discharge delay, the weld controller 228 may cause the capacitor 226 to be discharged through the electrode 220, thereby forming the weld at the welding surface. In some embodiments, the discharge delay may be in a range having an upper value, a lower value, or upper and lower values including any of 100 microseconds, 150 microseconds, 200 microseconds, 250 microseconds, 300 microseconds, 350 microseconds, 400 microseconds, 450 microseconds, 500 microseconds, 550 microseconds, 600 microseconds, 650 microseconds, 700 microseconds, 750 microseconds, 800 microseconds, 900 microseconds, 950 microseconds, 1,000 microseconds, 1,100 microseconds, 1,250 microseconds, 1,500 microseconds, or any value therebetween. For example, the discharge delay may be greater than 100 microseconds. In another example, the discharge delay may be less than 1,500 microseconds. In yet other examples, the discharge delay may be any value in a range between 100 microseconds and 1,500 microseconds. In some embodiments, it may be critical that the discharge delay is between 300 microseconds and 900 microseconds to ensure that the welding arc is properly formed between the electrode 220 and the welding surface.

The weld controller 228 includes an ignition manager 234. The ignition manager 234 may be in communication with an ignitor 236. The power source 224 may provide power to the ignitor 236 to apply an ignition current to the electrode 220. The ignition current may be a relatively low current applied to the electrode 220 to begin the electrical connection between the electrode 220 and the welding surface prior to the discharge of the capacitor 226. Conventionally, welding systems utilizing a low welding energy (e.g., less than 15 J) do not apply an ignition current to an electrode prior to discharging the capacitor. This may result in inconsistent welds, failure to form an arc between the electrode, generation of welds that are too small, too large, or do not sufficiently bond two metals. In some embodiments, the ignition current may be in a range having an upper value, a lower value, or upper and lower values including any of 0.25 A, 0.5 A, 0.75 A, 1.0 A, 1.25 A, 1.5 A, 1.75 A, 2.0 A, 2.25 A, 2.5 A, 2.75 A, 3.0 A, 3.5 A, 4.0 A, 4.5 A, 5.0 A, 6.0 A, 7.0 A, 8.0 A, 9.0 A, 10.0 A, or any value therebetween. For example, the ignition current may be greater than 0.25 A. In another example, the ignition current may be less than 10.0 A. In yet other examples, the ignition current may be any value in a range between 0.25 and 10.0 A. In some embodiments, it may be critical that the ignition current is between 0.5 and 1.5 A to improve the quality of the weld.

When the weld controller 228 receives the trigger, the ignition manager 234 may cause the ignitor 236 to apply the ignition current to the electrode 220. In accordance with at least one embodiment of the present disclosure, the ignitor 236 applies the ignition current throughout the discharge delay between receiving the trigger (and beginning of the discharge delay) and the discharge of the capacitor. In some embodiments, the ignitor 236 may apply the ignition current through the entire weld process. For example, the ignitor 236 may apply the ignition current the discharge of the capacitor until the capacitor is fully discharged. In some embodiments, the ignitor 236 may apply the ignition current until the arc has formed between the electrode 220 and the welding surface. In accordance with at least one embodiment of the present disclosure, the power source 224 may include a separate ignition power circuit for the ignitor 236 and capacitor power circuit for the capacitor 226. The ignitor 236 may include any type of ignitor. For example, the ignitor 236 may include an ignition resistor to generate the ignition current at the electrode. In some examples, the ignition resistor may include a plurality of resistors that are selectable based on the capacitor energy.

The weld controller 228 includes an electrode retraction manager 238. The electrode retraction manager 238 may cause an electrode retractor 240 to retract the electrode 220 into the stylus in which the electrode 220 is housed. The electrode retractor 240 may retract the electrode 220 in any manner. For example, the electrode retractor 240 may include a solenoid. When the solenoid is powered, the electromagnetic field may cause a metal armature or other metal element connected to the electrode 220 to linearly move. This may cause the electrode 220 to retract into the stylus. A biasing element or spring may push the electrode 220 in the opposite direction. When the electrode retractor 240 depowers the solenoid, the biasing element or spring may push the electrode 220 back to the starting position or neutral position. In some embodiments, the spring may bias the electrode 220 toward the retracted position, and powering the electrode retractor 240 may cause the electrode 220 to move toward the extended position. The electrode retractor 240 may include any other type of retractor. For example, the electrode retractor 240 may include a linear motor, a worm gear, a hydraulic piston, a pneumatic piston, any other retractor, and combinations thereof.

The weld controller 228 may begin retraction of the electrode 220 at the start of the discharge delay. For example, the weld controller 228 may begin retraction of the electrode 220 when the weld controller 228 receives the trigger to initiate the weld. This may result, in accordance with at least one embodiment, in the electrode 220 being located displaced away from the welding surface when the capacitor 226 is discharged. Discharging the capacitor 226 away from the welding surface when the capacitor 226 is discharged may facilitate an improved weld and/or reduce wear and/or damage to the electrode 220.

The electrode retractor 240 may retract the electrode 220 with a retraction rate, which may be the rate at which the electrode 220 travels into the stylus. In some embodiments, the retraction rate may be in a range having an upper value, a lower value, or upper and lower values including any of 10 mm/s, 20 mm/s, 30 mm/s, 40 mm/s, 50 mm/s, 60 mm/s, 70 mm/s, 80 mm/s, 90 mm/s, 100 mm/s, 150 mm/s, 200 mm/s, 300 mm/s, 400 mm/s, 500 mm/s, or any value therebetween. For example, the retraction rate may be greater than 10 mm/s. In another example, the retraction rate may be less than 500 mm/s. In yet other examples, the retraction rate may be any value in a range between 10 mm/s and 500 mm/s. In some embodiments, it may be critical that the retraction rate is between 50 mm/s and 100 mm/s to sufficiently move the electrode 220 during the discharge delay to generate an arc between the electrode 220 and the welding surface.

In some embodiments, the retraction rate may be constant. For example, the retraction rate of the electrode 220 may result in a linear retraction or change in the distance between a tip of the electrode 220 and the welding surface. In some embodiments, the retraction rate may be variable. For example, the retraction may be variable or non-linear based on the actuation pattern of the electrode retractor 240, based on the spring force of the biasing member connected to the electrode 220, or otherwise variable. The retraction rates discussed herein may be average retraction rates. In some embodiments, the variable or non-linear retraction rate of the electrode retractor 240 may be theoretically and/or empirically determined.

As discussed herein, after receiving the trigger and during the discharge delay, the ignitor 236 may apply the ignition current to the electrode 220. In accordance with at least one embodiment of the present disclosure, the ignitor 236 may apply the ignition current to the electrode 220 while the electrode retractor 240 is retracting the electrode 220. For example, the ignitor 236 may start to apply the ignition current while the electrode 220 is in contact with the welding surface and maintain the ignition current on the electrode 220 while the electrode 220 is retracting. In some examples, the ignitor 236 may start to apply the ignition current after the tip of the electrode 220 is left contact with the welding surface but before the end of the discharge delay.

When the discharge delay ends, the tip of the electrode 220 may be located a tip offset from the welding surface. For example, the tip offset may be the distance between the tip of the electrode 220 and the welding surface. In accordance with at least one embodiment of the present disclosure, the tip offset may be based on the welding energy. For example, a relatively smaller welding energy may be associated with a relatively smaller tip offset, and a relatively larger welding energy may be associated with a relatively larger tip offset. Basing the tip offset on the welding energy may facilitate improved arc formation during discharge of the capacitor 226. For example, a tip offset that is too large may result in the arc between the tip of the electrode 220 and the welding surface not forming and/or forming weakly. This may result in an inferior weld. A tip offset that is too small may result in the arc between the tip of the electrode 220 and the welding surface engaging the electrode 220, thereby damaging the electrode 220, resulting in increased maintenance and/or premature replacement of the electrode 220. Testing of the techniques of at least one embodiment, including generating the tip offset based on the welding energy, resulted in an increase in the operational life of the electrode 220 of approximately 100× compared to conventional techniques.

In some embodiments, the discharge delay may be based on the retraction rate and the tip offset. For example, as discussed herein, the tip offset may be based on the welding energy. Using the retraction rate and the tip offset, the discharge delay may be generated. In this manner, and in accordance with at least one embodiment, the discharge delay may be based on the welding energy.

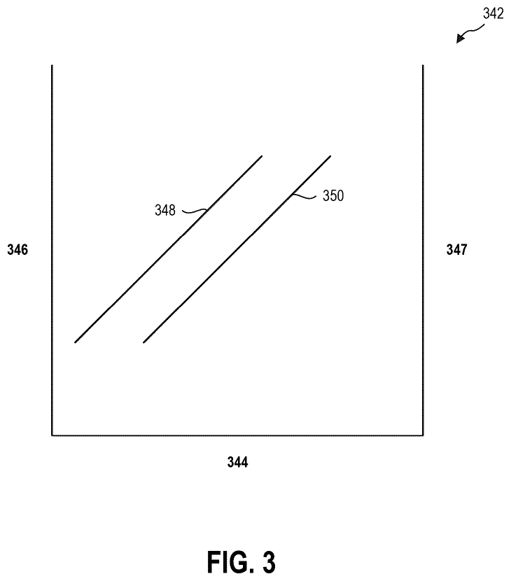

FIG. 3 is a relationship plot 342 of a relationship between welding energy 344 illustrated on the x-axis (e.g., horizontal axis), ignition current 346 illustrated on the left y-axis (e.g., left vertical axis), and tip offset 347 on the right y-axis (e.g., right vertical axis), according to at least one embodiment of the present disclosure. An ignition current line 348 illustrates the relationship between the welding energy 344 and the ignition current 346. As may be seen, the ignition current 346 is directly related to the welding energy 344. For example, as the welding energy 344 increases, the ignition current 346 increases. As the welding energy 344 decreases, the ignition current 346 decreases. This may facilitate improved weld quality and/or consistency.

In accordance with at least one embodiment of the present disclosure, the ignition current line 348 may be linear. For example, as the welding energy 344 changes, there is a commensurate linear change in the ignition current 346. However, it should be understood that the ignition current line 348 (e.g., the relationship between the welding energy 344 and the ignition current 346) may be any relationship, including parabolic, exponential, hyperbolic, any other relationship, and combinations thereof.

In a specific, non-limiting example, at a welding energy 344 of approximately 1 J, the ignition current 346 may be approximately 400 microseconds. At a welding energy of 3 J, the ignition current may be approximately 500 microseconds. At a welding energy of 5 J, the ignition current may be approximately 700 microseconds. At a welding energy of 7 J, the ignition current may be approximately 725 microseconds. At a welding current of 10 J, the ignition current may be approximately 750 microseconds.

A tip offset line 350 illustrates the relationship between the welding energy 344 and the tip offset 347. As may be seen, the tip offset 347 is directly related to the welding energy 344. For example, as the welding energy 344 increases, the tip offset 347 increases. As the welding energy 344 decreases, the tip offset 347 decreases. This may facilitate improved weld quality and/or consistency.

In accordance with at least one embodiment of the present disclosure, the tip offset line 350 may be linear. For example, as the welding energy 344 changes, there is a commensurate linear change in the tip offset 347. However, it should be understood that the tip offset line 350 (e.g., the relationship between the welding energy 344 and the tip offset 347) may be any relationship, including parabolic, exponential, hyperbolic, any other relationship, and combinations thereof.

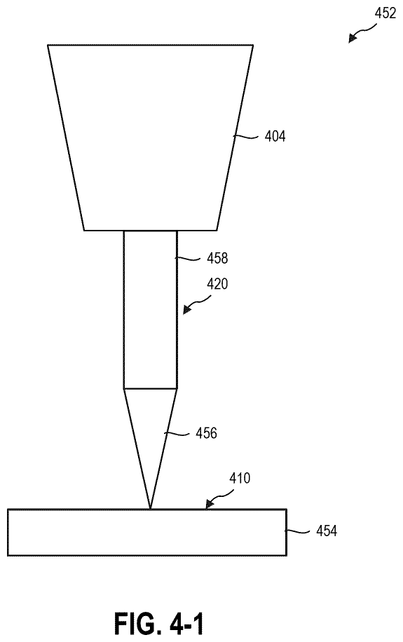

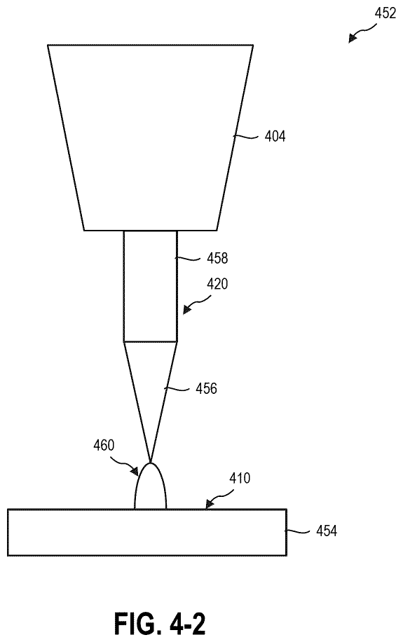

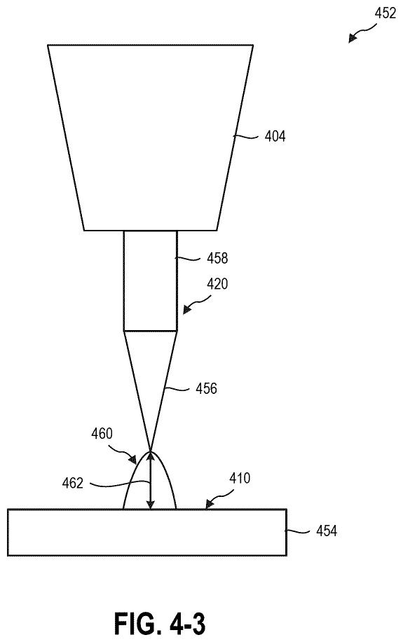

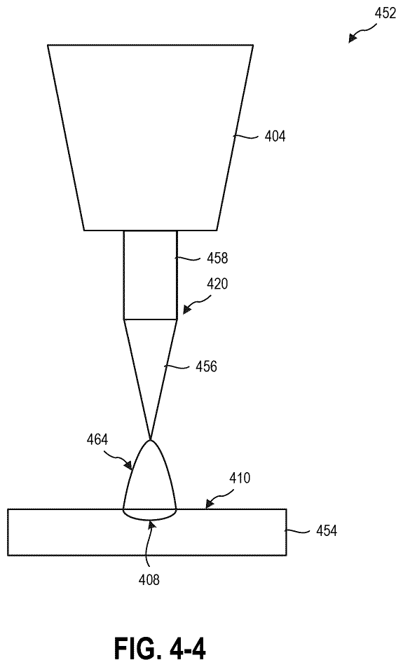

FIG. 4-1 through FIG. 4-4 illustrate a schematic representation of a welding sequence 452 at different times, according to at least one embodiment of the present disclosure. In FIG. 4-1, at time t-1, an electrode 420 extending out of a stylus 404 is in contact with a weld surface 410 of a weld material 454. For example, an electrode tip 456 of the electrode 420 may be in physical contact with the weld surface 410 of the electrode tip 456. An electrode body 458 may extend into the stylus 404. For example, the stylus 404 may be hollow and/or include an electrode chamber or path into which the electrode body 458 may extend.

At time t-1 the capacitor may be charged (e.g., the capacitor 226 of FIG. 2) and the weld controller (e.g., the weld controller 228 of FIG. 2) may receive a trigger to initiate the weld. As discussed herein, the capacitor may be variably chargeable to various capacitor energies As discussed herein, the trigger may be any trigger, such as the contact of the electrode tip 456 with the weld surface 410, which may close a circuit with the weld material 454. In some embodiments, the trigger may include a user input.

When the weld controller receives the trigger, at time t-1, an ignitor (e.g., the ignitor 236 of FIG. 2) may apply an ignition current to the electrode 420. The ignition current may flow through the electrode body 458, into the electrode tip 456, and into the weld material 454. Further, at time t-1, an electrode retractor (e.g., the electrode retractor 240 of FIG. 2) may start a retraction process to cause the electrode 420 to retract into the stylus 404, as may be seen in FIG. 4-2. As discussed herein, time t-1, when the weld controller receives the trigger, may be the start of the discharge delay.

At time t-1.5, as illustrated in FIG. 4-2, the electrode 420 may be partially retracted into the stylus 404 while maintaining the ignition current between the electrode 420 and the weld material 454. This may result in the formation of a low-power arc 460 between the electrode tip 456 and the weld material 454. Time t-1.5 may be a time between t-1 and the end of the discharge delay (e.g., time t-2).

At time t-2, as illustrated in FIG. 4-3, the electrode 420 may be located a tip distance 462 away from the weld surface 410. For example, based on the retraction of the electrode 420, the electrode 420 may have traveled the tip distance 462 during the discharge delay (e.g., the time between t-1 and t-2). When the electrode 420 is located the tip distance 462 away from the weld surface 410, and after the discharge delay, the weld controller may initiate the weld and begin discharge of the capacitor.

The discharge of the capacitor may occur over a discharge period. The discharge period may be any amount of time. For example, the discharge period may be approximately 1 millisecond. The end of the discharge delay may be the start of the discharge period. The tip distance 462 at the end of the discharge delay and the start of the discharge period may be in in a discharge position. The discharge position may be in a range having an upper value, a lower value, or upper and lower values including any of 10 micrometers, 20 micrometers, 30 micrometers, 40 micrometers, 50 micrometers, 60 micrometers, 70 micrometers, 80 micrometers, 90 micrometers, 100 micrometers, 150 micrometers, 200 micrometers, 250 micrometers, 500 micrometers, 1,000 micrometers, or any value therebetween. For example, the discharge position may be greater than 10 micrometers. In another example, the discharge position may be less than 1,000 micrometers. In yet other examples, the discharge position may be any value in a range between 10 micrometers and 1,000 micrometers. In some embodiments, it may be critical that the discharge position is between 10 micrometers and 100 micrometers to maintain improve formation of an arc and/or improve weld quality without forming a weld between the electrode 420 and the weld material 454.

At time t-2, the ignitor may maintain the ignition current on the electrode 420. This may maintain the low-power arc 460 between the electrode tip 456 and the weld material 454. At time t-3, in FIG. 4-4, the capacitor has discharged, resulting in a weld arc 464. The weld arc 464 may result in the formation of plasma between the electrode tip 456 and the weld material 454, heating the weld material 454 and resulting in the formation of a weld 408.

As may be seen, the electrode 420 may continue to retract between time t-2 and time t-3. This may result in the electrode tip 456 being offset from the weld material 454 at the time of formation of the weld arc 464 and the weld 408, thereby reducing the temperature to which the electrode tip 456 is subjected, preventing the formation of the weld 408 when the electrode tip 456 is in contact with the weld material 454, and extending the operational lifetime of the electrode 420.

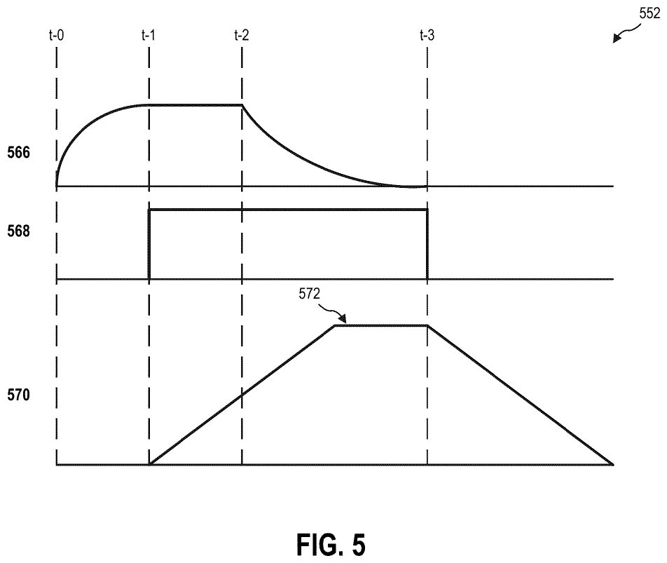

FIG. 5 is a representation of a welding sequence 552 illustrating capacitor charge 566, ignition current 568, and tip offset 570, with time on the x-axis (e.g., horizontal axis), according to at least one embodiment of the present disclosure. The times t-0, t-1, t-2, and t-3 may be associated with the welding sequence 452 discussed herein with respect to FIG. 4. At time t-0, the weld controller may charge the capacitor to the capacitor charge 566 associated with the welding energy. As discussed herein, the capacitor may be chargeable to a variable capacitor energy. At time t-1, the capacitor may be charged, and the weld controller may receive the trigger to initiate the weld. In some embodiments, the capacitor may be held at the capacitor charge 566 associate with the welding energy until the weld controller receives the trigger. Between time t-0 and time t-1, the ignition current 568 may be zero (e.g., no application of the ignition current to the electrode. Further, between time t-0 and time t-1, the electrode may be in the extended position.

At time t-1, the weld controller may receive the trigger and cause the ignition current 568 to be applied to the electrode and the beginning of the electrode retraction. Time t-1 may be the start of the discharge delay. At time t-2, after the discharge delay, the capacitor may begin to be discharged. The time between time t-1 and time t-2 may be the discharge delay. During the discharge delay, the ignition current 568 may be applied to the electrode and the tip offset 570 may increase as the electrode is retracted.

At time t-3, the capacitor may be discharged. As may be seen, during the time between time t-2 and time t-3, the weld controller may maintain the ignition current 568. Further, during the time between time t-2 and time t-3, the weld controller may continue to retract the electrode until the tip offset 570 reaches a maximum offset 572. The electrode may remain at the maximum offset until time t-3. After the weld is completed (e.g., after time t-3), the ignition current 568 may be withdrawn and the electrode may be extended, thereby reducing the tip offset 570.

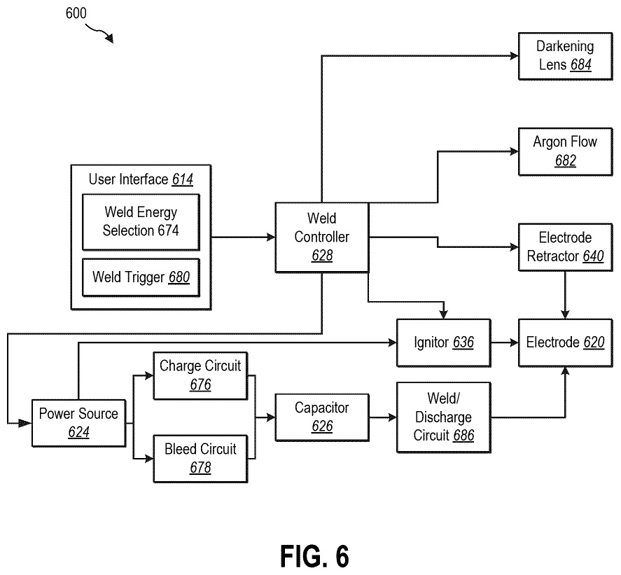

FIG. 6 is a representation of a welding system 600, according to at least one embodiment of the present disclosure. When the user desires to perform a weld, the user may select, via a user interface 614, a weld energy selection 674. A weld controller 628 may cause a power source 624 to charge a capacitor 626. The power source 624 may charge the capacitor 626 through a charge circuit 676 and a bleed circuit 678. The charge circuit 676 and the bleed circuit 678 may cause the capacitor 626 to charge to a capacitor charge associated with the selected welding energy and to maintain the capacitor 626 at the capacitor charge. As discussed herein, the capacitor 626 may be variably chargeable by the charge circuit 676 and the bleed circuit 678 to the capacitor energy.

When the weld controller 628 receives a weld trigger 680 to initiate the weld, the weld controller 628 may cause an ignitor 636 to apply an ignition charge to an electrode 620. Further, the weld controller 628 may cause an electrode retractor 640 to begin retraction of the electrode 620.

The weld controller 628 may cause other systems to activate at or after the time it receives the weld trigger 680. For example, the weld controller 628 may cause the start of an argon flow 682 and/or cause a darkening lens 684 to begin darkening. The argon flow 682 may isolate the weld from oxygen and prevent oxidation during the high temperatures of the weld. Darkening the darkening lens 684 may prevent eye damage to the user during the weld. For example, the user may view the welding area through the darkening lens 684. When the user triggers the weld trigger 680, the weld controller 628 may cause the darkening lens 684 to darken, thereby protecting the user's eyes from the bright flash of the weld forming.

After the discharge delay, the weld controller 628 may cause a weld and discharge circuit 686 to discharge the capacitor 626 through the electrode 620. This may result in the formation of the weld.

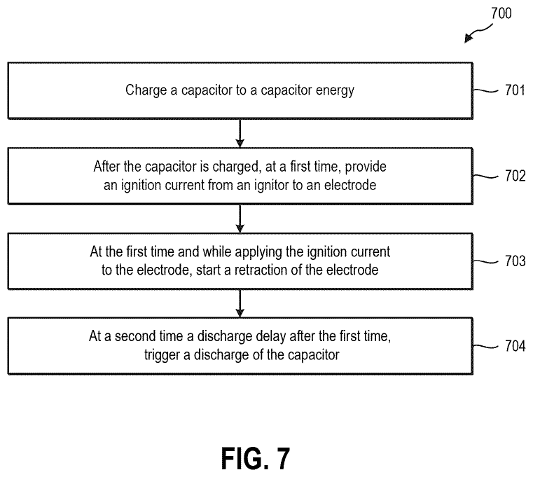

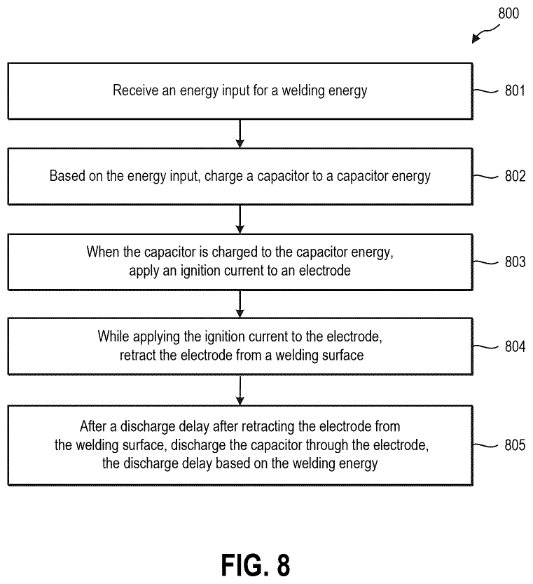

FIGS. 7 and 8, the corresponding text, and the examples provide a number of different methods, systems, devices, and computer-readable media of the _ system _. In addition to the foregoing, one or more embodiments can also be described in terms of flowcharts comprising acts for accomplishing a particular result, as shown in FIGS. 7 and 8. FIGS. 7 and 8 may be performed with more or fewer acts. Further, the acts may be performed in differing orders. Additionally, the acts described herein may be repeated or performed in parallel with one another or parallel with different instances of the same or similar acts.

As mentioned, FIG. 7 illustrates a flowchart of a series of acts or a method 700 for welding, according to at least one embodiment of the present disclosure. While FIG. 7 illustrates acts according to one embodiment, alternative embodiments may omit, add to, reorder, and/or modify any of the acts shown in FIG. 7. The acts of FIG. 7 can be performed as part of a method. Alternatively, a computer-readable medium can comprise instructions that, when executed by one or more processors, cause a computing device to perform the acts of FIG. 7. In some embodiments, a system can perform the acts of FIG. 7.

A weld controller may charge a capacitor to a capacitor energy at 701. As discussed herein, the capacitor may be variably chargeable to different capacitor energies. The capacitor energy may be associated with a welding energy selected by a user. After the capacitor is charged, and at a first time, the weld controller may provide an ignition current from an ignitor to an electrode at 702. At the first time, and while applying the ignition current to the electrode, the weld controller may start retraction of the electrode at 703. At a second time, the second time a discharge delay after the first time, the weld controller may trigger a discharge of the capacitor at 704.

As mentioned, FIG. 8 illustrates a flowchart of a series of acts or a method 800 for welding, according to at least one embodiment of the present disclosure. While FIG. 8 illustrates acts according to one embodiment, alternative embodiments may omit, add to, reorder, and/or modify any of the acts shown in FIG. 8. The acts of FIG. 8 can be performed as part of a method. Alternatively, a computer-readable medium can comprise instructions that, when executed by one or more processors, cause a computing device to perform the acts of FIG. 8. In some embodiments, a system can perform the acts of FIG. 8.

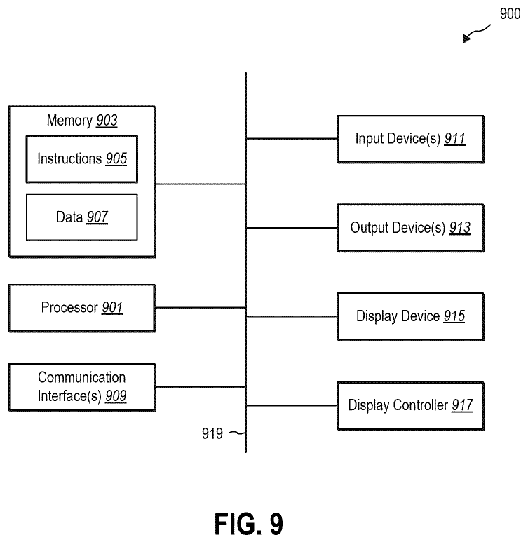

A weld controller may receive an energy input for a welding energy at 801. The weld controller may, based on the energy input, charge a capacitor to a capacitor energy at 802. The capacitor energy may be based on the welding energy. The weld controller may, when the capacitor is charged to the capacitor energy, apply an ignition current to an electrode at 803. While applying the ignition current to the electrode, the weld controller may retract the electrode from a welding surface at 804. After a discharge delay after retracting the electrode from the welding surface, the weld controller may discharge the capacitor through the electrode at 805. The discharge delay may be based on the welding energy. FIG. 9 illustrates certain components that may be included within a computer system 900. One or more computer systems 900 may be used to implement the various devices, components, and systems described herein.

The computer system 900 includes a processor 901. The processor 901 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 901 may be referred to as a central processing unit (CPU). Although just a single processor 901 is shown in the computer system 900 of FIG. 9, in an alternative configuration, a combination of processors (e.g., an ARM and DSP) could be used.

The computer system 900 also includes memory 903 in electronic communication with the processor 901. The memory 903 may be any electronic component capable of storing electronic information. For example, the memory 903 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 905 and data 907 may be stored in the memory 903. The instructions 905 may be executable by the processor 901 to implement some or all of the functionality disclosed herein. Executing the instructions 905 may involve the use of the data 907 that is stored in the memory 903. Any of the various examples of modules and components described herein may be implemented, partially or wholly, as instructions 905 stored in memory 903 and executed by the processor 901. Any of the various examples of data described herein may be among the data 907 that is stored in memory 903 and used during execution of the instructions 905 by the processor 901.

A computer system 900 may also include one or more communication interfaces 909 for communicating with other electronic devices. The communication interface(s) 909 may be based on wired communication technology, wireless communication technology, or both. Some examples of communication interfaces 909 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 900 may also include one or more input devices 911 and one or more output devices 913. Some examples of input devices 911 include a keyboard, mouse, microphone, remote control device, button, joystick, trackball, touchpad, and lightpen. Some examples of output devices 913 include a speaker and a printer. One specific type of output device that is typically included in a computer system 900 is a display device 915. Display devices 915 used with embodiments disclosed herein may utilize any suitable image projection technology, such as liquid crystal display (LCD), light-emitting diode (LED), gas plasma, electroluminescence, or the like. A display controller 917 may also be provided, for converting data 907 stored in the memory 903 into text, graphics, and/or moving images (as appropriate) shown on the display device 915.

The various components of the computer system 900 may be coupled together by one or more buses, which may include a power bus, a control signal bus, a status signal bus, a data bus, etc. For the sake of clarity, the various buses are illustrated in FIG. 9 as a bus system 919.

Embodiments of the present disclosure may thus utilize a special purpose or general-purpose computing system including computer hardware, such as, for example, one or more processors and system memory. Embodiments within the scope of the present disclosure also include physical and other computer-readable media for carrying or storing computer-executable instructions and/or data structures, including applications, tables, data, libraries, or other modules used to execute particular functions or direct selection or execution of other modules. Such computer-readable media can be any available media that can be accessed by a general purpose or special purpose computer system. Computer-readable media that store computer-executable instructions (or software instructions) are physical storage media. Computer-readable media that carry computer-executable instructions are transmission media. Thus, by way of example, and not limitation, embodiments of the present disclosure can include at least two distinctly different kinds of computer-readable media, namely physical storage media or transmission media. Combinations of physical storage media and transmission media should also be included within the scope of computer-readable media.

Both physical storage media and transmission media may be used temporarily store or carry, software instructions in the form of computer readable program code that allows performance of embodiments of the present disclosure. Physical storage media may further be used to persistently or permanently store such software instructions. Examples of physical storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored as or in software, hardware, firmware, or combinations thereof.

A “network” or “communications network” may generally be defined as one or more data links that enable the transport of electronic data between computer systems and/or modules, engines, and/or other electronic devices. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instructions or data structures and which can be accessed by a general purpose or special purpose computer.

Further, upon reaching various computer system components, program code in the form of computer-executable instructions or data structures can be transferred automatically or manually from transmission media to physical storage media (or vice versa). For example, computer-executable instructions or data structures received over a network or data link can be buffered in memory (e.g., RAM) within a network interface module (NIC), and then eventually transferred to computer system RAM and/or to less volatile physical storage media at a computer system. Thus, it should be understood that physical storage media can be included in computer system components that also (or even primarily) utilize transmission media.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A welding system, comprising:
a power source;
a capacitor connected to the power source, the capacitor variably chargeable to a capacitor energy;
an ignitor connected to the power source, the ignitor having an ignition current of between 0.5 A and 4 A;
an electrode connected to the capacitor and the ignitor; and
an electrode retractor connected to the electrode to move the electrode between an extended position and a retracted position.

2. The welding system of claim 1, wherein the ignitor has the ignition current of approximately 1 A.

3. The welding system of claim 1, wherein the ignitor includes an ignition resistor to generate the ignition current at the electrode.

4. The welding system of claim 3, wherein the ignition resistor includes a plurality of resistors selectable based on the capacitor energy.

5. The welding system of claim 1, wherein the capacitor energy is between 1 J and 30 J.

6. The welding system of claim 1, wherein the capacitor energy is between 1 J and 15 J.

7. The welding system of claim 1, further comprising a weld controller, the weld controller causing the capacitor to discharge with a discharge delay based on the capacitor energy, the discharge delay being between 300 microseconds and 900 microseconds.

8. A method for welding, comprising:
charging a capacitor to a capacitor energy;
after the capacitor is charged to the capacitor energy, and at a first time, providing an ignition current from an ignitor to an electrode;
at the first time and while applying the ignition current to the electrode, starting a retraction of the electrode from an extended position to a retracted position; and
at a second time a discharge delay after the first time, triggering a discharge of the capacitor.

9. The method of claim 8, wherein the discharge delay is between 300 microseconds and 900 microseconds.

10. The method of claim 8, wherein the discharge delay is based on the capacitor energy.

11. The method of claim 10, wherein the discharge delay is 300 microseconds when the capacitor energy is approximately 1 J.

12. The method of claim 8, wherein charging the capacitor includes charging the capacitor to the capacitor energy based on a selected welding energy.

13. The method of claim 8, wherein, at the second time, the electrode is at a discharge position between the retracted position and the extended position.

14. The method of claim 13, wherein the discharge position is based on the capacitor energy.

15. A method for welding, the method comprising:
receiving an energy input for a welding energy;
based on the energy input, charging a capacitor to a capacitor energy;
when the capacitor is charged to the capacitor energy, applying an ignition current to an electrode;
while applying the ignition current to the electrode, retracting the electrode from a welding surface; and
after a discharge delay after retracting the electrode from the welding surface, discharging the capacitor through the electrode, the discharge delay based on the welding energy.

16. The method of claim 15, further comprising: when the capacitor is charged to the welding energy, receiving a weld trigger, wherein applying the ignition current includes applying the ignition current based on the weld trigger.

17. The method of claim 16, wherein the weld trigger includes sensing that the electrode is in contact with the welding surface.

18. The method of claim 15, wherein discharging the capacitor includes discharging the capacitor while the electrode is not in contact with the welding surface.

19. The method of claim 15, wherein, when the welding energy is 1 J, the ignition current is approximately 1 A, and the discharge delay is approximately 300 microseconds.

20. The method of claim 15, wherein, when the welding energy is 15 J, the ignition current is approximately 1 A, and the discharge delay is approximately 900 microseconds.
